(19) United States
(12) Patent Application Publication
(10) Pub. No.: US 2026/0002594 A1
(43) Pub. Date: Jan. 1, 2026

(54) VALVE DIAPHRAGM COMPRISING FUNCTIONAL REGIONS, AND DIAPHRAGM VALVE

(71) Applicant: GEMÜ Gebr. Müller Apparatebau GmbH & Co. Kommanditgesellschaft, Ingelfingen (DE)

(72) Inventors: Michael Klemt, Pfedelbach (DE); Steffen Meinikheim, Ingelfingen (DE); Thomas Rüeck, Rosenberg (DE)

(21) Appl. No.: 19/247,517

(22) Filed: Jun. 24, 2025

(30) Foreign Application Priority Data
Jun. 26, 2024 (DE) 10 2024 118 041.2

(51) Int. Cl. F16K 7/14

(52) U.S. Cl. CPC F16K 7/14

(57) ABSTRACT

A valve diaphragm for a diaphragm valve includes a clamping section aligned with an imaginary vertical plane of an actuation axis, and a functional section surrounded by the clamping section. The functional section includes at least two flexing sections and a web-shaped sealing section that separates the flexing sections and connects two portions of the clamping section. The sealing section is configured to have, at least in part, a greater compressive yield point and/or a smaller compression set in a direction perpendicular to its longitudinal extent than along its longitudinal extent. This directional difference in mechanical properties allows the sealing section to maintain dimensional stability under compressive load while permitting flexibility along its length for improved sealing performance and durability.

### TECHNICAL FIELD

This disclosure relates to diaphragm valves and components thereof, particularly valve diaphragms and valve bodies used in fluid flow control systems.

### BACKGROUND

Diaphragm valves are commonly used to regulate fluid flow in systems where factors such as cleanliness, flow accuracy, or resistance to corrosion are important. Typical applications include semiconductor manufacturing, pharmaceutical processing, and food and beverage production. A diaphragm valve typically includes a valve diaphragm that separates the fluid pathway from the actuating mechanism. The valve diaphragm often comprises multiple regions configured for different operational roles. For instance, a sealing section engages a valve seat to block a through-line in the closed position, while one or more flexing sections allow displacement between open and closed positions. A clamping section secures the diaphragm within the valve assembly. The functional requirements of these regions differ significantly, placing contrasting demands on the material and structural characteristics of the diaphragm. This has presented challenges in achieving a balance between flexibility, sealing integrity, and long-term mechanical durability.

### SUMMARY

The present disclosure provides a valve diaphragm for a diaphragm valve, which is structurally and/or materially optimized in different regions to accommodate distinct mechanical functions such as sealing, flexing, and clamping.

In one aspect, a valve diaphragm comprises: a clamping section following an imaginary vertical plane of an actuation axis, and a functional section surrounded by the clamping section. The functional section comprises at least two flexing sections; and at least one web-shaped sealing section separating the at least two flexing sections from one another, wherein the sealing section has a greater compressive yield point and/or a smaller compression set perpendicular to its longitudinal extent than along its longitudinal extent.

In order to form a different compressive yield point and/or a different compression set perpendicular to and along the longitudinal extent of the sealing section, one, several or all of the following features can be provided: different thickness along or perpendicular to the longitudinal extent of the sealing section; insertion of a stiffening element tapering perpendicular to the longitudinal extent in or on the sealing section; gradual addition of additive along or perpendicular to the longitudinal extent of the sealing section; different additive in the sealing section; material gradient in the sealing section towards the flexing section and/or towards the clamping section, for instance, due to a temperature difference and/or due to a different processing time in the manufacturing process of the sealing section; different materials in the sealing section, for instance, along or perpendicular to the longitudinal extent of the sealing web; preferred direction of the material in the manufacturing process, for instance, due to material application during processing or drawing as a post-processing step.

The formation of a different compressive yield point and/or a different compression set along and perpendicular to the longitudinal extent of the sealing section (anisotropic) results in advantageous behavior of the scaling section when interacting with a valve seat of a diaphragm valve. This results in reinforcement in the dynamically pressure-loaded region along the sealing section. There is a slight material deformation perpendicular to the longitudinal extent of the sealing section so that a secure seal is achieved at the sealing section. At the same time, elasticity is ensured along the longitudinal extent so that the sealing section can adapt to the valve seat. Furthermore, the transition between the force-transmitting sealing section and the flexing region can be optimally designed.

According to one aspect of the disclosure, a ratio between the compressive yield point of the sealing section perpendicular to its longitudinal extent and the compressive yield point of the scaling section along its longitudinal extent lies in a range between, and inclusive of, 10:1 and 1.1:1, in some aspects, between and inclusive of 5:1 and 2:1, and in some aspects, between and inclusive of 4:1 and 3:1, and/or wherein a ratio between the compression set of the sealing section perpendicular to its longitudinal extent and the compression set of the sealing section along its longitudinal extent lies in a range between, and inclusive of, 10:1 and 1.1:1, between, and inclusive of, 5:1 and 2:1, and in some aspects, between, and inclusive of 4:1 and 3:1. Consequently, the valve diaphragm is optimally adapted to the different regions and/or functions.

According to one aspect of the present disclosure, a valve diaphragm for a diaphragm valve is provided. The valve diaphragm comprises: a clamping section following an imaginary vertical plane of an actuation axis, and a functional section surrounded by the clamping section; wherein the functional section comprises: at least two flexing sections; and at least one web-shaped sealing section separating the at least two flexing sections from one another. The two flexing sections have a greater compression set and/or a smaller compressive yield point than the clamping section.

According to one aspect of the present disclosure, a ratio between the compression set of the flexing sections and the compression set of the clamping section lies in a range between, and inclusive of 10:1 and 1.1:1, between and inclusive of 5:1 and 2:1, and in some aspects, between and inclusive of 4:1 and 3:1. In some aspects of the present disclosure, a ratio between the compressive yield point of the flexing sections and the compressive yield point of the clamping section lies in a range between and inclusive of 1:10 and 1:1.1, between and inclusive of 1:5 and 1:2, and in some aspects, between and inclusive of 1:4 and 1:3.

A different compression set and/or a different compressive yield point can be caused by different crosslinking characteristics of the utilized elastomer material. In some aspects of the present disclosure, the different sections are made of one, and in certain aspects, the same, elastomer.

According to one aspect of the present disclosure, the valve diaphragm comprises: a clamping section following an imaginary vertical plane of an actuation axis, and a functional section surrounded by the clamping section; wherein the functional section comprises: at least two flexing sections; and at least one web-shaped sealing section separating the at least two flexing sections from one another; wherein the sealing section has a greater compressive yield point and/or a smaller compression set than the at least two flexing sections or clamping section. Alternatively or additionally, the sealing section has a greater compression set than the clamping section.

To form a different compressive yield point and/or a different compression set in different regions of the valve diaphragm one, several or all of the following features may be provided: different thickness on or in the clamping section and/or on or in the functional section, in particular on or in the sealing section and/or on or in the flexing section; insertion of a stiffening element in or on the sealing section; additive along the longitudinal extent of the sealing section; different additive in the sealing section and/or in the clamping section and/or in the flexing section; material gradient in the sealing section towards the flexing section and/or towards the clamping section, for instance, due to a temperature difference and/or due to a different processing time in the manufacturing process of the valve diaphragm; different materials in the sealing section, in particular on the central web and/or outer web, and/or in the flexing section and/or in the clamping section; preferred direction of the material in the manufacturing process, for instance, due to material application during processing, drawing as a post-processing step.

The formation of a different compressive yield point and/or a different compression set in the sealing section and in the flexing sections results in advantageous behavior of the valve diaphragm during operation. The individual regions are configured according to their requirements during operation. This yields a reinforcement at the sealing section, which is advantageous for forming and sealing at the valve seat. Furthermore, due to high flexibility, the flexing sections are configured for the flexing movement during operation. The result is a reliable and wear-resistant valve diaphragm.

In some aspects of the present disclosure, a ratio between the compressive yield point of the sealing section and the compressive yield point of the at least two flexing sections and/or the clamping section lies in a range between and inclusive of 10:1 and 1.1:1, between and inclusive of 5:1 and 2:1, and in some aspects, between and inclusive of 4:1 and 3:1, and/or wherein a ratio between the compression set of the sealing section and the compression set of the at least two flexing sections lies in a range between and inclusive of 1:10 and 1:1.1, between and inclusive of 1:5 and 1:2, and in some aspects, between and inclusive of 1:4 and 1:3, and/or wherein a ratio between the compression set of the sealing section and the clamping section lies in a range between and inclusive of 10:1 and 1.1:1, between and inclusive of 5:1 and 2:1, and/or between and inclusive of 4:1 and 3:1. Consequently, the valve diaphragm is optimally adapted to the different regions and/or functions.

According to one aspect of the present disclosure, the compressive yield point and/or the compression set of the sealing section can be and/or is to be measured by a measurement parallel to the actuation axis. The compressive yield point and/or the compression set of the scaling section is measurable and/or to be measured perpendicular to its longitudinal extent by a measurement parallel to the actuation axis or perpendicular to the actuation axis and perpendicular to its longitudinal extent. The compressive yield point and/or the compression set of the sealing section is measurable and/or to be measured along its longitudinal extent by a measurement parallel to its longitudinal extent. The respective measurement can be performed either on the valve diaphragm as a whole or on a cut-out part of the valve diaphragm. To measure the compressive yield point, a known compression test for determining flow curves can be used, for instance, the standard DIN EN ISO 604 for plastics, the standard DIN ISO 7743 for elastomers, and the standard DIN EN 2850 for fiber-reinforced plastics. To measure the compression set, a known compression test can be used, for instance, the standard DIN ISO 815.

According to one aspect of the present disclosure, the compressive yield point of the sealing section, for instance, perpendicular to its longitudinal extent, is greater than 0.1 N/mm2, 0.2 N/mm2, and/or 0.5 N/mm2, and/or less than 10 N/mm2, 5 N/mm2, and in some aspects, 2 N/mm2, and/or wherein the compression set of the sealing section, for instance, perpendicular to its longitudinal extent, is greater than 2%, 5%, 10%, and/or less than 40%, 35%, and/or 30% or less.

In accordance with some aspects of the present disclosure, the sealing section has a variable compressive yield point and/or a variable compression set along its longitudinal extent. Accordingly, the transition between the sealing section and the clamping section can be optimally adjusted. In some aspects, the reinforcement decreases towards the clamping section. In certain aspects, the sealing section on the pressure piece is reinforced.

In accordance with some aspects of the present disclosure, the sealing section has a first web section and two second web sections facing the clamping section, wherein the first web section is arranged between the second web sections, wherein the first web section has a greater compressive yield point and/or a smaller compression set than the second web sections.

According to one aspect of the present disclosure, the valve diaphragm comprises: a clamping section following an imaginary vertical plane of an actuation axis, and a functional section surrounded by the clamping section; wherein at least the functional section comprises a reinforcement structure whose strands extend transversely, for instance, perpendicularly, to the longitudinal extent of a sealing section of the functional section.

In aspects, the regions of the valve diaphragm, for instance, the sealing section, can be optimally adapted to the individual functions.

In accordance with some aspects of the present disclosure, the reinforcement structure is configured as a reinforcement fabric and/or the strands are configured as weft threads. Due to the directional arrangement of the weft threads, the flow of the sealing section can be significantly reduced, which has a positive influence on sealing. The weft threads are arranged transversely or perpendicularly to the longitudinal extent, for instance if at least 50%, at least 70% and, in some aspects, at least 90% of the weft threads are arranged transversely or perpendicularly to the longitudinal extent.

According to one aspect of the present disclosure, the reinforcement fabric further comprises warp threads running transversely, for instance, perpendicularly, to the weft threads. Alternatively, other weaving techniques, such as denim, and/or other knitted structures can be utilized.

According to some aspects of the present disclosure, a weft thread spacing between the weft threads is smaller than a warp thread spacing of the warp threads. In some aspects, flow transversely or perpendicularly to the longitudinal extent of the sealing section can be further reduced.

According to one aspect of the present disclosure, a ratio between the weft thread spacing and the warp thread spacing lies in a range between and inclusive of 1:1.2 and 1:10, 1:2 and 1:7, and in some aspects 1:3 and 1:5.

In accordance with one aspect of the present disclosure, the reinforcement structure is arranged in a region facing a wet side of the valve diaphragm, for instance, at a height of ⅓ of the vertical extent of the valve diaphragm, for example, of the sealing section. The vertical extent runs parallel to the actuation axis and extends from a first side facing the through-line during operation and a second side facing away from the first side.

The clamping section and/or the functional section and/or the flexing sections and/or the sealing section are connected before or after shaping, for instance by welding, gluing and/or direct stitching. In some aspects, a carrier layer is provided in which the regions are formed differently by different manufacturing processes.

According to one aspect of the present disclosure, a diaphragm valve with a previously described valve diaphragm is provided wherein the sealing section of the valve diaphragm cooperates with a valve seat of the diaphragm valve for closing a through-line of the diaphragm valve.

### BRIEF DESCRIPTION OF THE DRAWINGS

Further advantages and aspects of this disclosure emerge from the claims and from the following description of preferred exemplary embodiments of this disclosure, which are explained below with reference to the figures. Identical and functionally corresponding elements are provided with identical reference signs. In the drawings:

FIG. 1a-c shows a schematic view of a valve diaphragm;

FIG. 2a-c shows a schematic view of a first embodiment of the valve diaphragm;

FIG. 3 shows a schematic plan view of a second embodiment of the valve diaphragm; and

FIG. 4a-d shows a schematic plan view of further embodiments of the valve diaphragm.

### DETAILED DESCRIPTION

Conventional valve diaphragms used in diaphragm valves often experience uneven mechanical loading across their different functional regions, such as the sealing section, flexing sections, and clamping section. These regions are subjected to conflicting performance demands requiring both elasticity and dimensional stability. This can lead to excessive wear, loss of sealing integrity, or premature material fatigue. The present disclosure addresses this technical problem by providing a valve diaphragm in which directional mechanical properties, such as compressive yield point and compression set, are selectively varied across different regions of the diaphragm. In particular, anisotropic characteristics are introduced in the scaling section to balance dimensional stability under compressive load with elasticity along the valve seat. These properties may be achieved through reinforcement structures, material gradients, geometric variation, or combinations thereof.

Unless otherwise expressly indicated, the following terms have the meanings provided below. These definitions are intended to clarify, not limit, the scope of the claims.

As used herein, “compressive yield point” refers to the maximum compressive stress that a material or component can withstand before undergoing plastic (i.e., non-reversible) deformation. In a stress-strain diagram, the compressive yield point corresponds to the point at which the curve deviates from linear (clastic) behavior. The compressive yield point is expressed in N/mm² and may be determined using standard testing procedures, such as DIN EN ISO 604, DIN ISO 7743, or an equivalent.

As used herein, “compression set” refers to the amount of permanent deformation that remains in a material after it has been subjected to a compressive load for a defined time and then released. It is expressed as a percentage (%) of the original thickness lost due to the deformation. A lower compression set indicates better elastic recovery. Testing may be performed according to DIN ISO 815 or an equivalent standard.

As used herein, “longitudinal extent” refers to the principal axis or direction of the web-shaped sealing section that separates two flexing sections of the valve diaphragm. In some embodiments, this direction may be oriented generally parallel to the plane of the diaphragm and connect opposite regions of the clamping section.

As used herein, “perpendicular to the longitudinal extent” refers to a direction that is substantially orthogonal to the longitudinal extent of the sealing section. In many cases, this direction corresponds to the direction of loading along the actuation axis of the valve.

As used herein, “wet side” refers to the side of the valve diaphragm that is exposed to the working fluid in the valve chamber during operation. This side typically faces the through-line and valve seat of the diaphragm valve.

As used herein, “reinforcement fabric” refers to a fabric or fiber structure embedded in or bonded to the diaphragm material, which includes fibers oriented in different directions. The fabric may include “weft threads,” which run generally perpendicular to the longitudinal extent of the sealing section, and “warp threads,” which run transversely to the weft threads.

Unless otherwise specified, numerical ranges and ratio expressions used herein are intended to include the stated endpoints and all intermediate values. For example, a range from 1.1:1 to 10:1 includes 1.1:1, 10:1, and all values in between.

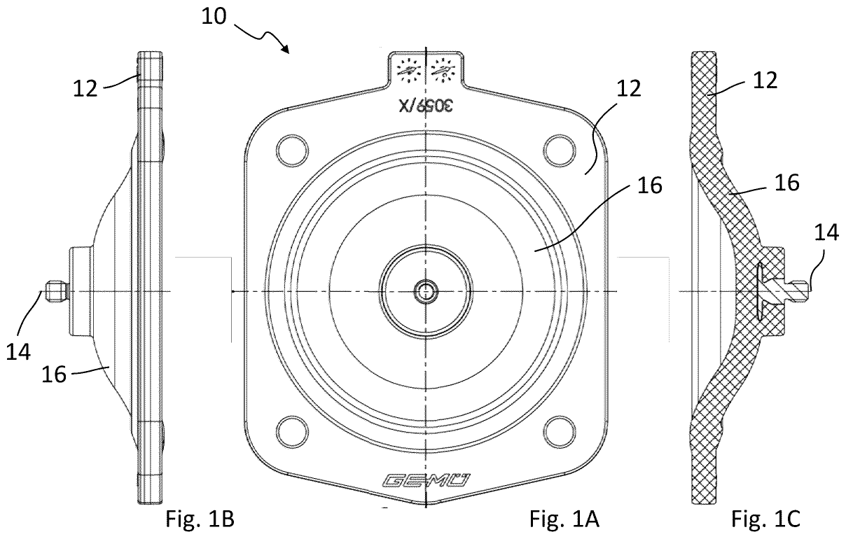

The valve diaphragm 10 according to FIG. 1 is suitable for use in a diaphragm valve (not shown). The valve diaphragm 10 has a plurality of functional regions.

The valve diaphragm 10 has a clamping section 12 which follows an imaginary vertical plane of an actuation axis 14. The clamping section 12 surrounds a functional section 16 which is substantially circular. The clamping section 12 serves to fix the valve diaphragm 10 to the diaphragm valve and is clamped between a housing part of the diaphragm valve and a housing part of the drive system. The clamping section 12 is statically stressed during operation of the diaphragm valve.

The clamping section 12 is securely clamped. It is therefore particularly important in this region that the clamping section 12 has a constant height parallel to the actuation axis 14. In this way, the valve diaphragm 10 is securely fixed under constant clamping conditions. However, the material undergoes compression deformation while under a load, which should be small in this case.

The functional section 16 has two flexing sections 18, a first flexing section 18A and a second flexing section 18B. The flexing sections 18 are separated from one another by a web-shaped sealing section 20. The valve diaphragm 10 is displaced in the region of the functional section 16 along the actuation axis 14 between an open position and a closed position. In the closed position, the sealing section 20 comes into contact with a valve seat and seals a through-line of a diaphragm valve. In the open position, the through-line is released. In FIG. 1, the valve diaphragm 10 is shown in the setting corresponding to the open position. To displace the functional section 16, the functional section 16 is connected to a drive rod and in particular to a pressure piece.

When the valve diaphragm 10 moves, the flexing sections 18 perform a flexing movement. The functional section 16, for instance, the sealing section 20 and/or the flexing sections 18, is/are exposed to a dynamic load during operation of the diaphragm valve. The dynamic loads differ between the sealing section 20 and the flexing sections 18.

The scaling section 20 is repeatedly pressed onto the valve seat so that compressive stress on the sealing section 20 occurs. The sealing section 20 must have an elasticity so that it comes into contact over the entire valve seat and therefore enables a secure seal. However, the elasticity is also adjusted in such a way that the sealing section 20 is dimensionally stable so that the material is not excessively deformed or displaced perpendicular to a longitudinal extent 22 of the sealing section 20.

The flexing sections 18 experience both compressive and tensile stresses during flexing so that they have a corresponding elasticity configured not break or tear.

The valve diaphragm has 10 different regions which are exposed to different loads and therefore place diametrically opposite requirements on the material.

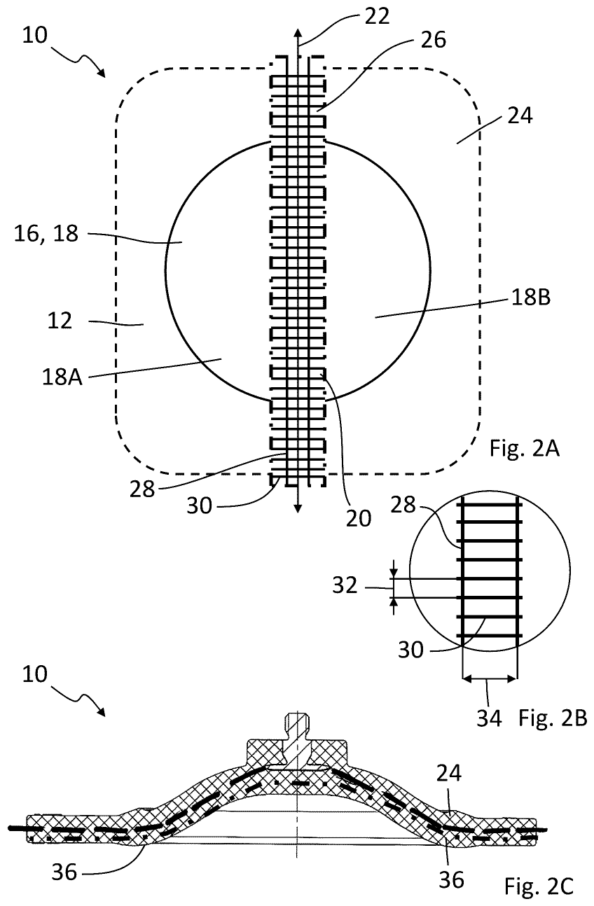

According to FIG. 2a-b, the valve diaphragm 10 has a continuous carrier material 24 (dashed line). In the region of the sealing section 20, a reinforcement structure 26 is provided (dash-dot line). The reinforcement structure 26 can extend into the clamping section 12 in extension of the longitudinal extent 22 of the sealing section 20 so that no predetermined breaking point arises between the dynamically loaded functional section 16 and the statically loaded clamping section 12. In some aspects, the reinforcement structure 26 is configured as a reinforcement fabric with warp threads 28 and weft threads 30. The reinforcement structure 26 can be formed from a single-layer or multi-layer reinforcement fabric.

The reinforcement structure 26 is arranged such that the warp threads 28 are arranged transversely to the longitudinal extent 22 of the sealing section 20. As used herein, “transverse to the longitudinal extent 22” is to be understood as “not parallel.” The warp threads 28 are not formed parallel to the longitudinal extent 22. The warp threads 28 are arranged at least substantially perpendicular, in some aspects, perpendicular, to the longitudinal extent 22 of the sealing section 20. The warp threads 28 can enclose an angle in the range between and inclusive of 60° and 120°, 75° and 105°, and in some aspects, 85° and 95°, with the longitudinal extent 22 of the sealing section 20. The weft threads 30 are arranged transversely to the warp threads 28. The weft threads 30 can be arranged at least substantially perpendicular, and, in some aspects, perpendicular, to the warp threads 28. The weft threads 30 can enclose an angle with the warp threads 28 in the range between and inclusive of 60° and 120°, 75° and 105°, and in some aspects, 85° and 95°. In a further aspect, the weft threads 30 and the warp threads 28 are interchanged in the arrangement to the longitudinal extent 22 of the sealing section 20. The angle specifications also apply in this embodiment, wherein the warp threads 28 and weft threads 30 are exchanged.

The sealing section 20 has a greater compressive yield point perpendicular to its longitudinal extent 22 than parallel to or along the longitudinal extent 22. The sealing section 20 has a smaller compression set perpendicular to its longitudinal extent 22 than parallel to or along the longitudinal extent 22.

FIG. 2b shows a detailed view of the sealing section 20 and the threads provided therein. To reduce the flow of the sealing section 20 perpendicular to the longitudinal extent 22 of the sealing section 20, the primary threads which are arranged transversely, in some aspects perpendicularly, to the longitudinal extent 22 of the sealing section 20, have a higher thread density than the secondary threads which are arranged transversely to the primary threads. If the weft threads 30 are arranged perpendicularly and the warp threads 28 are arranged parallel to the longitudinal extent 22 of the sealing section 20, the weft threads 30 have a weft thread spacing 32 between two adjacent weft threads 30, and the warp threads 28 have a warp thread spacing 34 between two adjacent warp threads 28, wherein the weft thread spacing 32 is smaller than the warp thread spacing 34. In some aspects of the present disclosure, a ratio between the weft thread spacing 32 and the warp thread spacing 34 is in a range between and inclusive of 1:1.2 and 1:10, 1:2 and 1:7, and in some aspects 1:3 and 1:5. The warp thread spacing 34 and/or the weft thread spacing 32 can be uniform or variable along the longitudinal extent 22 and/or perpendicular to the longitudinal extent 22, for instance decreasing towards the edges or increasing towards the edges.

To further improve the sealing section 20, the reinforcement structure 26 according to FIG. 2c is arranged in a region facing a wet side 36 of the valve diaphragm 10. The reinforcement structure 26 is arranged at a height of ⅓ of the vertical extent of the valve diaphragm 10 running parallel to the actuation axis 14. The reinforcement structure 26 is arranged in the region of the load from the seal.

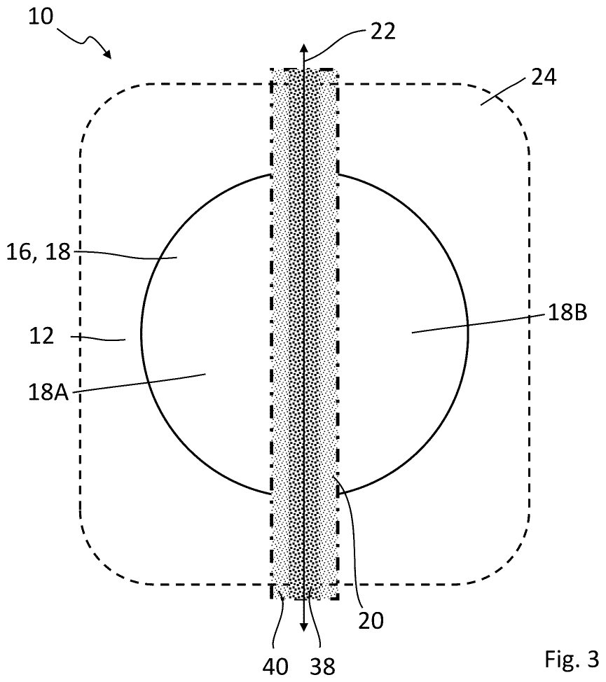

Alternatively, an anisotropy of the sealing section 20 can be realized by a material gradient. In FIG. 3, it is shown that the material in the sealing section 20 is configured as strip-shaped. The sealing section 20 has an inner strip 38 and two outer strips 40, wherein the inner strip 38 is arranged perpendicular to the longitudinal extent 22 between the outer strips 40. The inner strip 38 and the outer strips 40 can differ in that a different material is used, or that the material in the respective strip was treated differently in the manufacturing process, for example was manufactured with different temperatures and/or manufacturing times. The sealing section 20 can alternatively be configured such that the properties perpendicular to the longitudinal extent 22 change abruptly or smoothly from a central longitudinal axis to the edge. The sealing section 20 has different properties along the longitudinal extent 22 than transversely to the longitudinal extent 22. In some aspects, for example, the inner strip 38 is treated at a higher temperature or for a longer manufacturing time than the outer strips 40.

The sealing section 20 has a greater compressive yield point perpendicular to its longitudinal extent 22 than parallel to or along the longitudinal extent 22. The sealing section 20 has a smaller compression set perpendicular to its longitudinal extent 22 than parallel to or along the longitudinal extent 22.

The different treatment can extend into the clamping section 12 in extension of the longitudinal extent 22 of the sealing section 20 in order to avoid a predetermined breaking point at the transition.

In one aspect of the present disclosure, the compressive yield point of the scaling section 20, for instance perpendicular to its longitudinal extent 22, is greater than 0.1 N/mm2, 0.2 N/mm2, and/or 0.5 N/mm2, and/or less than 10 N/mm2, 5 N/mm2, and, in some aspects, 2 N/mm2. The compression set of the sealing section 20, for example, perpendicular to its longitudinal extent 22, is greater than 2%, 5%, and/or 10%, and/or less than 40%, 35%, and, in some aspects, 30% or less.

Alternatively or additionally, in some aspects, the sealing section 20 is formed with strips or variable material properties along its longitudinal extent 22. The transition can be abrupt or smooth. These can be adjusted, for example, by changing the warp thread spacing 34 or weft thread spacing 32 along the longitudinal extent 22 or by different production temperatures or times.

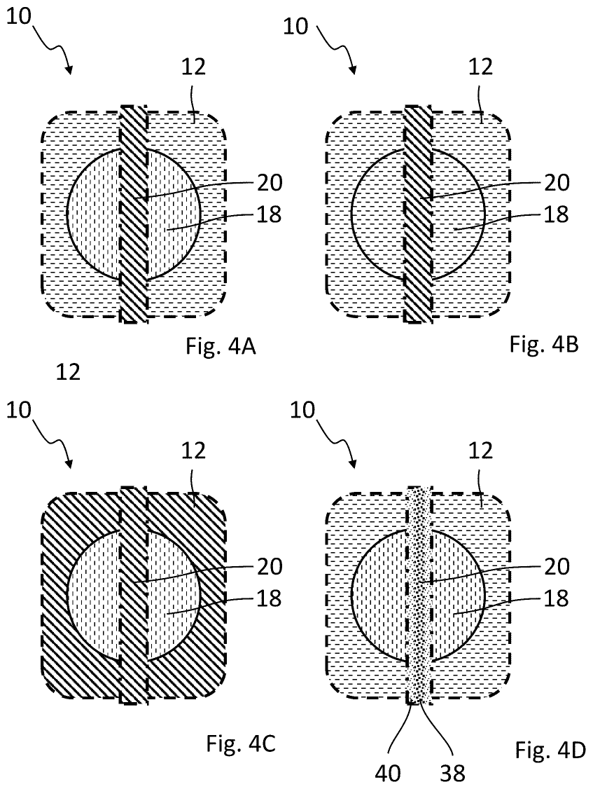

According to FIG. 4a-d, the sealing section 20, the clamping section 12 and the flexing section 18 can each have different component and/or material properties.

In FIG. 4a, the clamping section 12 has first component and/or material properties, the flexing sections 18 has a second component and/or material properties, and the sealing section 20 has third component and/or material properties, wherein they differ with regard to the compressive yield point and/or the compression set. The valve diaphragm 10 is configured such that the sealing section 20 has a smaller compression set and/or a greater compressive yield point than the two flexing sections 18. The valve diaphragm 10 is configured such that the scaling section 20 has a greater compression set and/or a smaller compressive yield point than the clamping section 12. The valve diaphragm 10 is configured such that the two flexing sections 18 have a greater compression set and/or a smaller compressive yield point than the clamping section 12. In aspects of this disclosure, the valve diaphragm 10 is configured to the functional regions and their requirements.

In FIG. 4b, the clamping section 12 and the flexing sections 18 have the same component and/or material properties, wherein these differ from the component and/or material properties of the scaling section 20.

In FIG. 4c, the clamping section 12 and the sealing section 20 have the same component and/or material properties, wherein these differ from the component and/or material properties of the flexing sections 18.

The embodiment according to FIG. 4d corresponds to that of FIG. 4a, wherein the sealing section 20 is additionally configured according to FIG. 2 with anisotropic component and/or material properties, or according to FIG. 3 with gradual component and/or material properties along and/or perpendicular to the longitudinal extent 22 of the sealing section 20.

According to some aspects of this disclosure, a ratio between the compressive yield point of the scaling section 20 and the compressive yield point of the at least two flexing sections 18 and/or the clamping section 12 is in a range between and inclusive of 10:1 and 1.1:1, between and inclusive of 5:1 and 2:1, and in some aspects between and inclusive of 4:1 and 3:1. According to some aspects, a ratio between the compression set of the sealing section 20 and the compression set of the at least two flexing sections 18 is in a range between an inclusive of 1:10 and 1:1.1, between and inclusive of 1:5 and 1:2, between and inclusive of 1:4 and 1:3. In some aspects, a ratio between the compression set of the sealing section 20 and the compression set of the clamping section 12 is in a range between and inclusive of 10:1 and 1.1:1, between and inclusive of 5:1 and 2:1, and in some aspects, between and inclusive of 4:1 and 3:1.

In one aspect, the compression set in the clamping section 12 is less than 20%, 15%, and, in some aspects, less than 10%.

As a result of the differentiated mechanical properties across its functional regions, the valve diaphragm disclosed herein provides improved durability, sealing performance, and operational reliability under dynamic and static loading conditions. The anisotropic scaling section enhances contact with the valve seat while minimizing material creep or flow, contributing to a more effective and longer-lasting seal. The flexible regions accommodate repeated flexing without tearing, and the clamping section maintains dimensional stability under compression. Additionally, the ability to tailor material properties through fabrication techniques or reinforcement structures allows for optimized performance using a single elastomeric base material, potentially simplifying manufacturing and reducing cost.

### LIST OF REFERENCE NUMBERS

10 Valve diaphragm
12 Clamping section
14 Actuation axis
16 Functional section
18 Flexing sections
18A First flexing section
18B Second flexing section
20 Sealing section
22 Longitudinal extent of the sealing section
24 Carrier material
26 Reinforcement structure
28 Warp threads
30 Weft threads
32 Weft thread spacing
34 Warp thread spacing
36 Wet side of the valve diaphragm
38 Inner strip of the sealing section
40 Outer strips of the sealing section

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

Persons skilled in the art will understand that the structures and methods specifically described herein and shown in the accompanying figures are non-limiting exemplary aspects, and that the description, disclosure, and figures should be construed merely as exemplary of aspects. It is to be understood, therefore, that the present disclosure is not limited to the precise aspects described, and that various other changes and modifications can be effected by one skilled in the art without departing from the scope or spirit of the disclosure.

Additionally, the elements and features shown or described in connection with certain aspects can be combined with the elements and features of certain other aspects without departing from the scope of the present disclosure, and that such modifications and variations are also included within the scope of the present disclosure. Accordingly, the subject matter of the present disclosure is not limited by what has been particularly shown and described.

What is claimed:

1. A valve diaphragm for a diaphragm valve, the valve diaphragm comprising:
a clamping section aligned with an imaginary vertical plane of an actuation axis; and
a functional section surrounded by the clamping section,
wherein the functional section comprises:
at least two flexing sections; and
at least one web-shaped sealing section separating the at least two flexing sections from one another and connecting two portions of the clamping section,
wherein the sealing section has, at least in part, a greater compressive yield point and/or a smaller compression set in a direction perpendicular to its longitudinal extent than in a direction along its longitudinal extent.

2. The valve diaphragm of claim 1, wherein:
a ratio between the compressive yield point of the sealing section perpendicular to its longitudinal extent and the compressive yield point along its longitudinal extent is from 1.1:1 to 10:1, inclusive; and/or
a ratio between the compression set of the sealing section perpendicular to its longitudinal extent and the compression set along its longitudinal extent is from 1.1:1 to 10:1, inclusive.

3. A valve diaphragm for a diaphragm valve, the valve diaphragm comprising:
a clamping section aligned with an imaginary vertical plane of an actuation axis; and
a functional section surrounded by the clamping section,
wherein the functional section comprises:
at least two flexing sections; and
at least one web-shaped sealing section separating the at least two flexing sections from one another,
wherein the flexing sections have a greater compression set and/or a smaller compressive yield point than the clamping section.

4. The valve diaphragm of claim 3, wherein:
a ratio between the compression set of the flexing sections and the compression set of the clamping section is from 1.1:1 to 10:1, inclusive; and/or
a ratio between the compressive yield point of the flexing sections and the compressive yield point of the clamping section is from 1:10 to 1:1.1, inclusive.

5. A valve diaphragm for a diaphragm valve, the valve diaphragm comprising:
a clamping section aligned with an imaginary vertical plane of an actuation axis; and
a functional section surrounded by the clamping section,
wherein the functional section comprises:
at least two flexing sections; and
at least one web-shaped sealing section separating the at least two flexing sections from one another,
wherein the sealing section has a greater compressive yield point and/or a smaller compression set than the flexing sections, and/or a greater compression set than the clamping section.

6. The valve diaphragm of claim 5, wherein:
a ratio between the compressive yield point of the sealing section and the compressive yield point of the flexing sections and/or the clamping section is from 1.1:1 to 10:1, inclusive;
a ratio between the compression set of the sealing section and the compression set of the flexing sections is from 1:10 to 1:1.1, inclusive; and/or
a ratio between the compression set of the sealing section and the compression set of the clamping section is from 1.1:1 to 10:1, inclusive.

7. The valve diaphragm of claim 1, wherein:
the compressive yield point and/or the compression set of the sealing section is measurable by a test conducted parallel to the actuation axis; and/or
the compressive yield point and/or compression set of the sealing section perpendicular to its longitudinal extent is measurable by a test conducted either parallel to the actuation axis or perpendicular to both the actuation axis and the longitudinal extent; and/or
the compressive yield point and/or compression set along the longitudinal extent is measurable by a test conducted parallel to the longitudinal extent.

8. The valve diaphragm of claim 1, wherein:
the compressive yield point of the sealing section perpendicular to its longitudinal extent is greater than or equal to 0.1 N/mm² and less than or equal to 10 N/mm²; and/or
the compression set of the sealing section perpendicular to its longitudinal extent is greater than or equal to 2% and less than or equal to 40%.

9. The valve diaphragm of claim 1, wherein the sealing section has a variable compressive yield point and/or a variable compression set along its longitudinal extent.

10. The valve diaphragm of claim 1, wherein:
the sealing section comprises a first web section positioned between two second web sections facing the clamping section; and
the first web section has a greater compressive yield point and/or a smaller compression set than the second web sections.

11. A valve diaphragm for a diaphragm valve, the valve diaphragm comprising:
a clamping section aligned with an imaginary vertical plane of an actuation axis; and
a functional section surrounded by the clamping section,
wherein the functional section comprises a reinforcement fabric having weft threads extending perpendicular to a longitudinal extent of a sealing section of the functional section.

12. The valve diaphragm of claim 11, wherein the reinforcement fabric further comprises warp threads extending transversely to the weft threads.

13. The valve diaphragm of claim 12, wherein a spacing between the weft threads is smaller than a spacing between the warp threads.

14. The valve diaphragm of claim 13, wherein a ratio between the weft thread spacing and the warp thread spacing is from 1:1.2 to 1:10, inclusive.

15. The valve diaphragm of claim 11, wherein the reinforcement fabric is positioned in a region of the valve diaphragm facing a wet side of the valve diaphragm, at a height of approximately one-third of the vertical extent of the valve diaphragm.

16. A diaphragm valve comprising the valve diaphragm of claim 1, wherein the scaling section of the valve diaphragm cooperates with a valve seat to close a through-line of the diaphragm valve.
